(19) United States
(12) Patent Application Publication
(10) Pub. No.: US 2020/0214501 A1
(43) Pub. Date: Jul. 9, 2020

(54) BATTERY ENABLED PELLET GRILL

(71) Applicant: W.C. BRADLEY CO., Columbus, GA (US)

(72) Inventors: ALEX GAFFORD, Midland, GA (US); RAMIN KHOSRAVI RAHMANI, Columbus, GA (US)

(21) Appl. No.: 16/734,131

(22) Filed: Jan. 3, 2020

Related U.S. Application Data
(60) Provisional application No. 62/788,508, filed on Jan. 4, 2019.

(51) Int. Cl. A47J 37/07; A23B 4/052; F23B 40/00

(52) U.S. Cl. CPC A47J 37/0704; A47J 37/079; A23V 2002/00; A23B 4/0523; F23B 40/00; A47J 37/0754

(57) ABSTRACT

A system includes a cooking chamber defining a space for food to be cooked, a firepot inside the cooking chamber that is configured to utilize pelletized fuel to provide heat or smoke within the cooking chamber for cooking the food, and a fuel hopper defining a storage space for the pelletized fuel before delivery to the firepot. A battery powered auger interposes the fuel hopper and the firepot and is configured to selectively convey the pelletized fuel from the fuel hopper to the firepot for combustion. A rechargeable battery selectively provides power to the auger.

### CROSS REFERENCE TO RELATED APPLICATION

This application claims the benefit of U.S. provisional patent application Ser. No. 62/788,508, filed on Jan. 4, 2019, and incorporates such provisional application by reference into this disclosure as if fully set out at this point.

### FIELD OF THE INVENTION

This disclosure relates to cooking grills in general and, more specifically, to battery-enabled pelleted-fueled cooking grills.

### BACKGROUND OF THE INVENTION

Pellet grills and smokers have been available since the mid-1980's. Some of these were based initially on U.S. Pat. No. 4,823,684 to Traeger et al. and U.S. Pat. No. 5,251,607 to Traeger et al. In their current state pellet grills or smokers may include a hopper, into which is loaded wooden fuel pellets. An electrically driven auger may be provided for conveying the fuel to a combustion chamber or firepot, in which the fuel is ignited, typically by an electric hot surface ignitor. Air may be supplied to the firepot by an electric fan. Hot gases produced by the high temperature wood fire may be manipulated to provided heat to a cooking area or chamber normally located above the firepot.

Presently, pellet grills and smokers are provided with a power cord for connection to an electrical outlet. The pellet grill or smoker so configured is not operable without a steady supply of household A/C power.

What is needed is a system and method for addressing the above, and related, problems.

### SUMMARY OF THE INVENTION

The invention of the present disclosure, in one aspect thereof, comprises a system having a cooking chamber defining a space for food to be cooked, a firepot inside the cooking chamber that is configured to utilize pelletized fuel to provide heat or smoke within the cooking chamber for cooking the food, and a fuel hopper defining a storage space for the pelletized fuel before delivery to the firepot. A battery powered auger interposes the fuel hopper and the firepot and is configured to selectively convey the pelletized fuel from the fuel hopper to the firepot for combustion. A rechargeable battery selectively provides power to the auger.

The system may further comprise a direct current, variable speed auger motor that rotates the auger. A user control may selectively activate the variable speed auger motor. Some embodiments further comprise a microcontroller selectively operating the variable speed auger motor in predetermined intervals of operation based on the user control. The microcontroller may selectively operate the variable speed auger motor at different speeds at different times based on the user control.

Some embodiments include an ignitor powered by the battery and configured to ignite fuel inside the firepot. The ignitor may be selectively activated by the microcontroller based on the user control. The system may include a fan powered by the battery and providing combustion air to the firepot. The fan may be selectively activated by the microcontroller based on the user control. The microcontroller may provide a control program for the ignitor, fan, and auger motor based on the user control. The program comprises at least one stage where the ignitor, fan, and auger motor are all active, at least one stage where the only the auger and fan are active, and at least one stage where only the fan is active.

Some systems include a battery compartment affixed to the cooking chamber and providing an electrical interface to the battery via the microcontroller. A battery charger operable on alternating current power and configured to recharge the battery may be included.

The invention of the present disclosure, in another aspect thereof, comprises a system having a cooking chamber that is provided heat and smoke from a firepot therein for preparing food inside the cooking chamber. A fuel hopper outside the cooking chamber is for receiving pelletized fuel. The system also includes an auger operable to move fuel from the fuel hopper into the firepot when rotated by an auger motor, an ignitor associated with the firepot for igniting fuel in the firepot, and a fan that provides combustion air under positive pressure into the firepot. The system also includes a battery that powers the auger motor, the ignitor, and the fan. A control circuit controls power to the auger motor, ignitor, and fan from the battery. A user control for activates the control circuit.

In some embodiments, the auger motor is a variable speed, direct current motor. The control circuit may comprise a microcontroller that selectively operates the auger motor, the ignitor, and the fan according to a program selected by the user control. The microcontroller may selectively operate the auger motor, the ignitor, and the fan according to the program selected by the user in stages, wherein the program has at least a stage where the ignitor, fan, and auger motor are all active, at least a stage where the only the auger and fan are active, and at least a stage where only the fan is active.

The invention of the present disclosure, in another aspect thereof, comprises a method including receiving pelletized cooking fuel in a hopper, moving the pelletized fuel from the hopper to a firepot, and combusting the pelletized fuel in the firepot to generate smoke and heat within a cooking chamber. The pelletized fuel is moved by an auger rotated by a battery powered variable speed motor.

In some embodiments, the method includes igniting the pelletized fuel in the firepot with a battery powered ignitor. The method may also include providing pressurized combustion air into the firepot with a battery powered fan.

The method may also include operating the auger, the ignitor, and the fan in stages comprising: at least one stage where the ignitor, fan, and auger motor are all active; at least one stage where the only the auger and fan are active; and at least one stage where only the fan is active.

### BRIEF DESCRIPTION OF THE DRAWINGS

FIG. 1 is frontal perspective partial view of a battery enabled, pellet fueled grill according to aspects of the present disclosure.

FIG. 2 is end perspective partial view of a battery enabled, pellet fueled grill according to aspects of the present disclosure.

FIG. 3 is a partial cutaway perspective view of a battery enabled, pellet fueled grill according to aspects of the present disclosure.

FIG. 4 is a schematic diagram of the relationship between various components of a battery enabled, pellet fueled grill according to aspects of the present disclosure.

FIG. 5 is a chart of electrical power consumption over time for a grill according to aspects of the present disclosure in a first mode of operation.

FIG. 6 is a chart of electrical power consumption over time for a grill according to aspects of the present disclosure in a second mode of operation.

FIG. 7 is a chart of electrical power consumption over time for a grill according to aspects of the present disclosure in a third mode of operation.

### DETAILED DESCRIPTION OF THE PREFERRED EMBODIMENTS

In association with a pellet grill or smoker, demand for electrical power may be considered as being comprised of a continual or intermittent demand for combustion air (depending upon when or how the product is being operated), and an intermittent demand for an auger feed and ignition (often linked together in frequency of occurrence). Variable on/off cycles may be employed to obtain different heating rates. In various embodiments, a peak power demand during operation is on the order of 250 to 300 watts.

Since pellet grills and smokers are often used for long cooking cycles of 2 to 8 hours, the total amount of energy needed to complete a cook cycle may be on the order of 500 watt-hours. This is entirely beyond the capacity of commercially available primary cells (non-rechargeable batteries). Customarily 110-120 V A/C power from household circuits is therefore utilized. This brings with it a number of disadvantages, including difficulty in locating the grill or appliance to an appropriate household location. It is sometimes the case that the smoke from pellet cookers or grills being used close to house structures is undesirable due to staining of the house, smoke intake into the house, or other factors. Concerns over electrical cords becoming unmanageable or potentially unsafe due to length needed, as well as operating in rainy or wet outdoor environments also exist. Of course, such an appliance cannot be operated in a power outage nor operated at a remote location without A/C power (as for weekend travel or sports events). Additionally, A/C variable-speed drives can be cost prohibitive and therefore certain operational states cannot be achieved or cannot be cost effectively achieved.

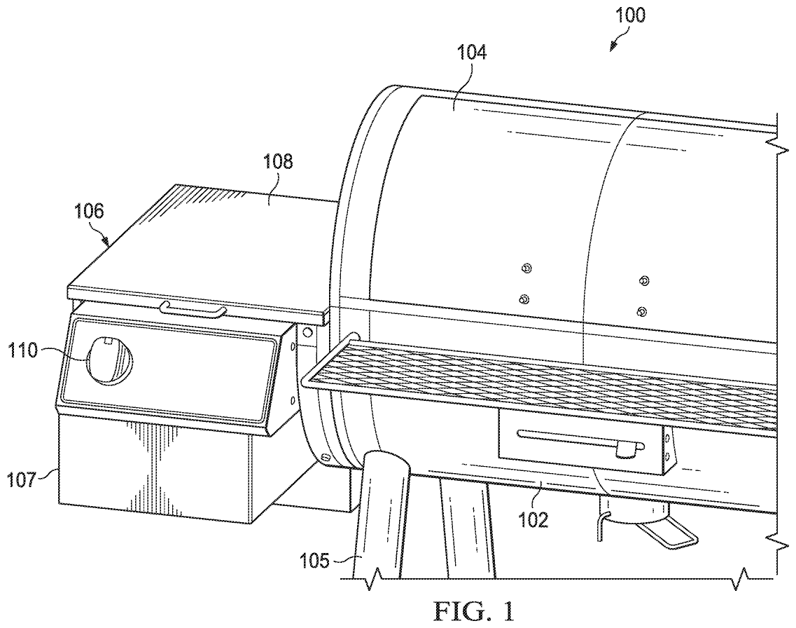

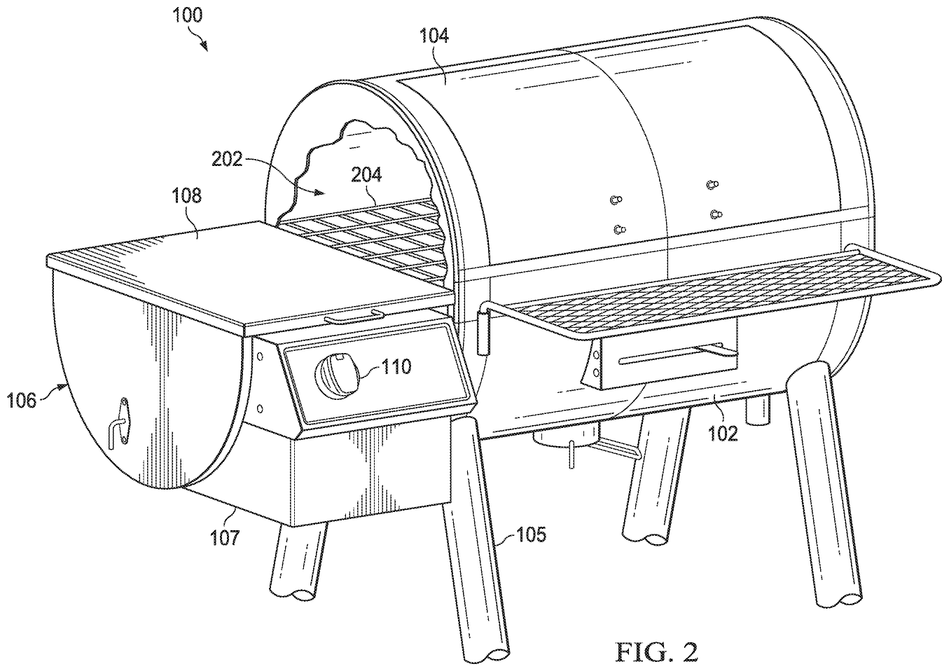

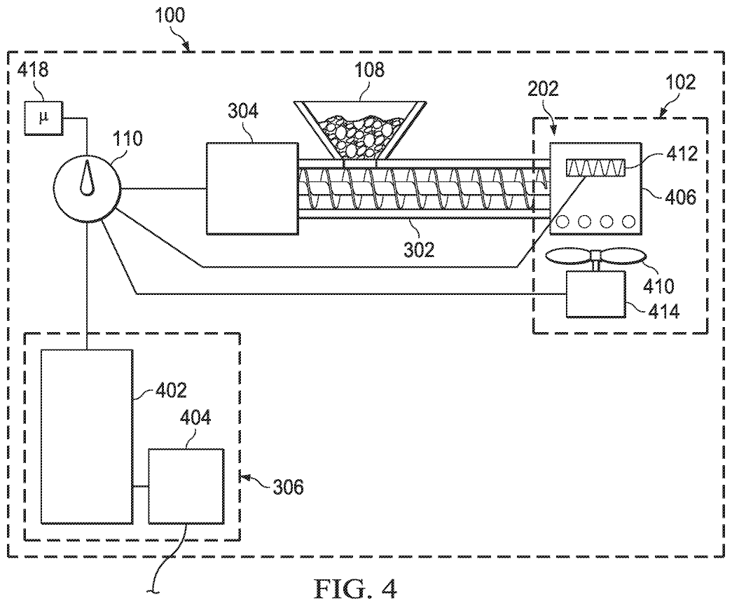

Various embodiments of the present disclosure address known shortcomings as described in the non-limiting examples that follow. Referring now to FIG. 1 a frontal perspective partial view of a pellet fueled grill 100 according to aspects of the present disclosure is shown. The grill 100 is also shown in an end perspective partial view in FIG. 2. The grill 100 comprises a firebox or cooking chamber 102 containing a fire pot (406, FIG. 4) that burns fuel pellets (such as wood pellets) for heat and smoke for cooking meat and other foods. The firebox 102 may be covered with a lid 104 or other openable cover as is known in the art. In various embodiments, the lid 104 may be hinged and/or openable in various user selectable sections at a time. In some embodiments, the firebox 102 and lid 104 together form a generally cylindrical or barrel shape.

Within the firebox 102 and/or lid 104 a cooking space 202 is defined where food preparation such as cooking, and smoking occurs. A food support surface or grate 204 may also be within the space 202, possibly supported by the firebox 102 above the firepot 406. The firebox 102 may rest on one or more legs 105. In some embodiments, one or more of the legs 105 may be wheeled for ease of movement or transport of the grill 102.

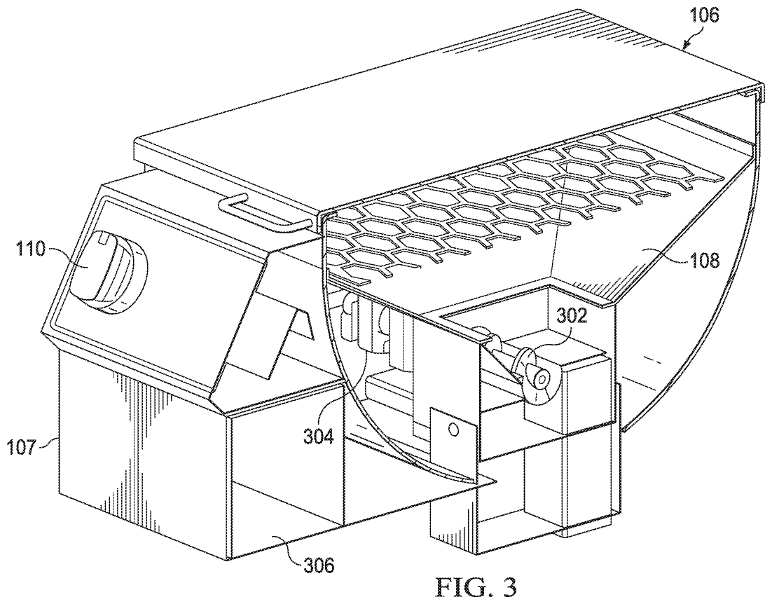

A pellet feeding hopper system 106 may selectively introduce fuel pellets into the firebox 102 and firepot providing an ongoing source of combustion fuel for heating the grill 100 and/or providing smoke. Note that the term “selective” or “selectively” means that the operation is capable of being performed but may not occur continuously or without interruption. The hopper system 106 may include a fuel hopper 108 and one or more user control knobs 110. Referring now also to FIG. 3 a partial cutaway perspective view of the pellet feeding hopper system 106 is shown to reveal an auger 302 that selectively pushes fuel pellets from a bottom of the hopper 108 into the firebox 102 (out of frame) and firepot.

The auger 302 may be driven by an electric motor 304 that responds to user input via the control knob 110. It should be understood that various internal control mechanisms may be associated with the one or more control knobs 110 that are accessible to the user. Without limitation these may include relays, potentiometers, switches, digital or analog electronic control mechanisms, and others as are known in the art. It should also be understood that other user accessible control mechanisms than knobs may be made available to use for controlling or accessing various functions associated with the grill 100. These may include, without limitation, switches, sliders, buttons, and digital control mechanisms as are known in the art. Electronic displays or additional control means as described may be installed on the same surface as the control knob 110.

In some embodiments a microcontroller or microprocessor 418 may be programmed or otherwise configured to control operation of the grill 100 based on input from the control knob 110 or other user controls. As is known in the art, various relays, amplifiers, resistors, and other components may allow the microprocessor 418 to interface with or control the powered components of the grill 100 and selectively connect or disconnect the same to battery 402. In some embodiments, the microprocessor 418 is configured to apply variable power or voltage to various components (e.g., motors 304, 414) to control speed of operations. In some embodiments, the microprocessor 418 may be considered a control circuit, with functionality that could also be implemented with analog components.

In some embodiments, the motor 304 may be operable on common household alternating current and voltages (e.g., 110V, 60 Hz in the US, 220V, 50 Hz in Europe, or others). In other embodiments, the motor 304 is a DC (direct current) motor and an AC/DC (alternating current to direct current) converter (not shown) may be employed. The motor 304 may also be selectively powered by a battery (e.g., 402, FIG. 4). As discussed in further detail below, the battery and possible charging components may be stored in, or be integral with, the grill 100. To that end, a secure storage location 306 may be provided as part of the pellet feeding hopper system 106 or elsewhere on the grill 100. The storage location, as shown here in one particular embodiment, is immediately below the panel housing the control knob 110. This location 306 may be made suitably weather or water resistant such that weather or rain will not damage sensitive electrical components or be likely to cause a short or other fault. The location 306 may also be far enough away from the firebox 102 such that there is not likely to be sufficient heating so as to damage components. In some embodiments, thermal insulation of the battery and electronic storage location 306 is provided for additional securement. In some embodiments, a user access door (not shown) is provided that allows the user to change batteries or service other electronic components associated with the pellet feeding hopper system 106. The storage location 306 may also be conveniently located at approximately waist height for many users.

Referring now to FIG. 4, a schematic diagram 400 of the battery enabled, pellet fueled grill 100 is shown. Here the auger 302 can be seen to selectively feed fuel (e.g., in the form of pellets) from the hopper 108 into the firepot 406 (which is in the firebox 102). The control knob 110 provides for selective powering of the motor 304 by a battery 402. The battery 402 may have a charger 404 associated therewith. These components may be stored in the storage location 306 allowing the battery 402 to be charged in situ.

Various control schemes or programs may be user selectable via the knob 110 or other controls. For example, the motor 304 and auger 302 may be thermostatically controlled based on temperature inside the firebox 102 as selected by a user on the control knob 110. In other embodiments, the auger 302 may be operated based on a timed basis (e.g., on for 10 seconds, off for 70 seconds, etc.). The duty cycle may be selectable via the knob with more frequent fueling of the firepot 406 resulting in hotter fires and/or more smoke in the firebox 102. In some embodiments, multiple control mechanisms and operating programs may be selectable by the user using the knob 110 or other controls. In some embodiments, the auger 302 may operate continuously at varying speeds (based, for example, on user control and/or temperature of the firebox 102).

In some embodiments, the motor 304 is a DC motor and may have variable speed capabilities. Voltage of the battery 402 may be 60 to 80 volts or less where a DC setup is utilized. In some embodiments, the grill 100 may be operable directly on AC (alternating current, as from an outlet) power. In some such embodiments, the battery 402 need not be charged or even present for the grill 100 to operate. If the motor 304 is a DC motor in such an embodiment, an AC/DC converter (not shown) may be utilized when a battery is not available to supply DC power to the motor 304.

As illustrated, the battery 402 is provided with an on-board charger 404 that is capable of charging the battery 402 via household A/C power. In such cases, the grill 100 can be operated away from power sources. In some embodiments, the battery 402 is changeable by a user. This may allow the user to simply change out a depleted battery for a fresh one. In such case, the charger 404 may not be included within the storage area 306 or any other location affixed to the grill 100. The charger 404 could be kept indoors, for example, or at any other convenient location near an outlet. In further embodiments, the charger 404 is selectively storable and/or operable within the grill 100. In such cases, a user may remove the charger 404 when it is not convenient or desirable to charge the battery 402 within the grill 100.

In further embodiments, the battery charger 402 is not compatible with being fitted into the storage space 306 or elsewhere on the grill 100 and charging must be accomplished separately from the grill 100. In such case, the grill 100 may not be provided with a power cord at all. However, in other embodiments the grill 100 is provided with an A/C connection that is only accessible when a battery is not installed in the appliance (e.g., the battery may physically block the A/C connection location). Batteries compatible with systems and methods of the present disclosure may also be rechargeable via solar power (either in/on the grill 100 or elsewhere) or other low-carbon energy sources.

A single battery 402 is shown but it is understood that multiple batteries may be used if needed. It should also be understood that the battery 402 may have multiple cells within, such that higher voltages may be achieved than with a single cell of a given battery chemistry. The battery 402 may utilize lithium-ion chemistry. In some embodiments, other battery chemistries are used. The grill 100 may also be configured such that a single battery provides necessary power to operate, but multiple batteries may be operationally connected to provide longer runtime. In some embodiments, the grill 100 is capable of operation using batteries of varying capacity (e.g., different voltages within a range of voltages and/or batteries providing different watt-hours and thus different runtimes).

In some embodiments, a battery connector may be used that is compatible with other devices. Thus, the battery 402 may be used for multiple applications in addition to the grill 100. For example, the battery 402 may be useful for powering the grill 100, but then can later be used to power a camping light, a power tool, or another device.

It should be understood that the battery 402 (or batteries if there are multiple batteries present) may provide power for components associated with the grill 100 other than the auger 302. For example, a combustion fan 410 driven by an electric motor 414 may provide air under positive pressure into the firebox 102 generally and, specifically, the firepot 406 to maintain proper ongoing combustion of the pellet fuel. In other embodiments, other fans may be utilized as well (for example, a fan to provide positive air flow from the hopper 108 and/or auger 302 and into or toward the firepot 406). Each fan and associated motor utilized with the grill 100 may be powered by the battery 402.

Similarly, an ignitor 412 may be used to provide for initial combustion of the fuel introduced to the firepot 406. The ignitor 412 may comprise a resistive heating element as is known in the art. Although the ignitor 412 represents a large load for a power source, it is not generally active the entire time the grill 100 is operational. It may be activated as needed when the grill 100 is first started and when introduction of additional fuel into the firepot 406 necessitates additional ignition heat.

In some embodiments, control of the fan, auger, and ignitor may be supervised by a microprocessor 414 or other electronic means (to include, non-exclusively, system-on-a-chip and other integrated circuit devices) and operating parameters may be displayed (on a segmented display, LED display, LCD display, or other). This control function may additionally be communicated to some remote application such as an iOT enabled device according to known wireless protocols. The electronics required for these control and communications means can be powered from a transformer connected to household A/C power or from a standalone primary (non-rechargeable) battery, or the battery 402. Thus, according to some embodiments, electrical power is used for four different functions: conveying the fuel, igniting the fuel, providing combustion air to the fuel, and enabling control and communications

Batteries useful with systems and methods of the present disclosure may vary in size in watt-hours (e.g., according to their energy capacity) to give desired lengths of service for cooking and costs. Suitable batteries may come in a range of, for example, 0.5 Kwh, 1.0 Kwh, 1.5 Khw, and so on. Batteries to be used according to the present disclosure may be modular. They may have a common charging interface, and may have at least two of their three spatial dimensions common to allow configuration of the grill 100 to readily accept any of the batteries.

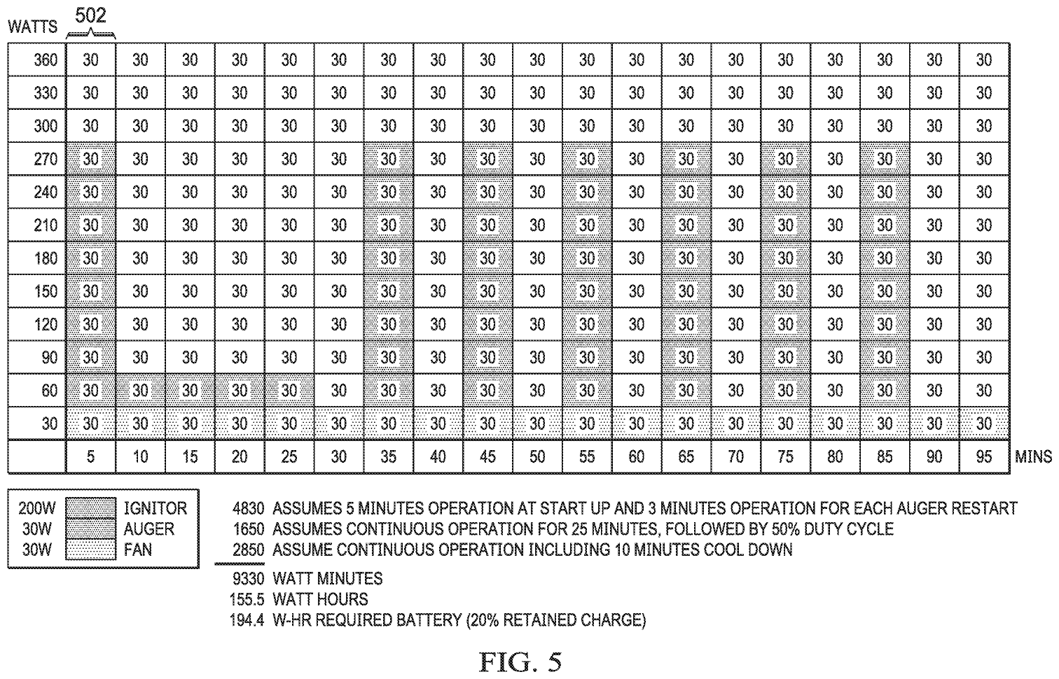

Battery capacity and technology has now reached the point where commercially-available or off-the-shelf rechargeable batteries may be sufficient for applications including at least some embodiments of devices and methods of the present disclosure. FIG. 5 provides a chart illustrating the total power requirement for a grill according to the present disclosure operated over 95 minutes. The table illustrates power required every 5 minutes in blocks of 30 watts. Each of these 5-minute blocks may be considered a stage 502. Various cooking methods may be considered as being constructed of various stages with different operational and power parameters. It can be seen that, in one embodiment, a maximum power requirement on any stage 502 is 270 watts. The allows for continuous operation of the fan at 30 watts and intermittent operation of the auger and ignitor as shown. Added up, the total requirement is 194.4 watt-hours, well within the limit for commercially available lithium ion battery technology.

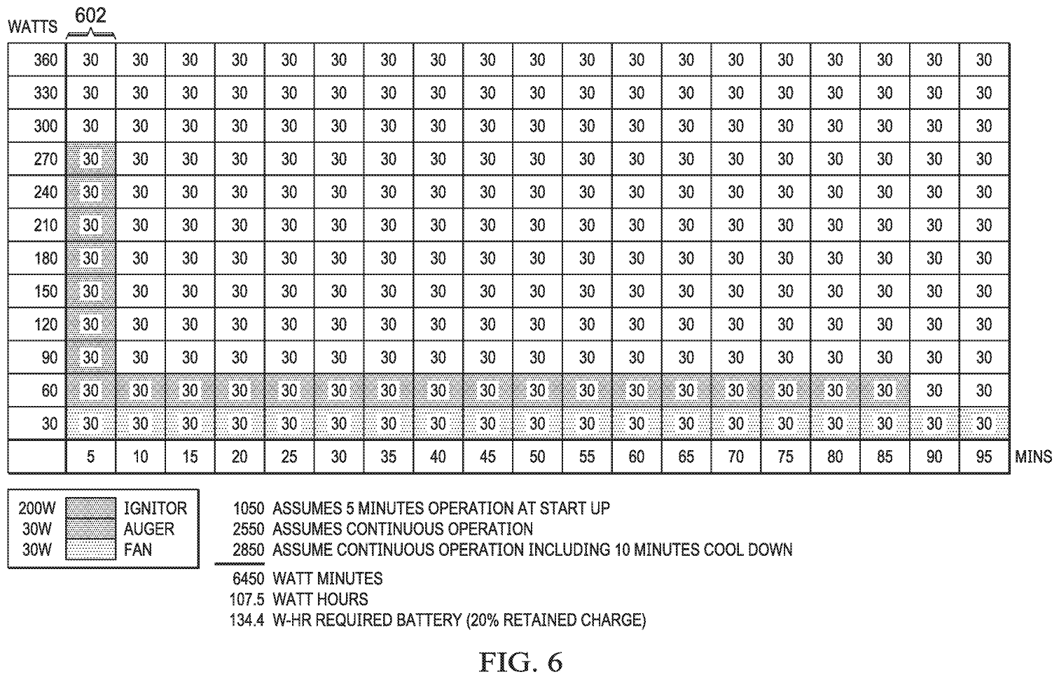

FIG. 6 illustrates another mode of operation for a grill according to the present disclosure. Again, the mode or method is shown in terms of 5-minute stages 602. Here the ignitor is powered only at startup. The auger is powered continuously (possibly at relatively low speed) for most of the cooking cycle (until the final burn and cool down phase). The fan runs continuously throughout this cycle. It can be seen that over a 95-minute cook cycle, 134.4 watt-hours are required.

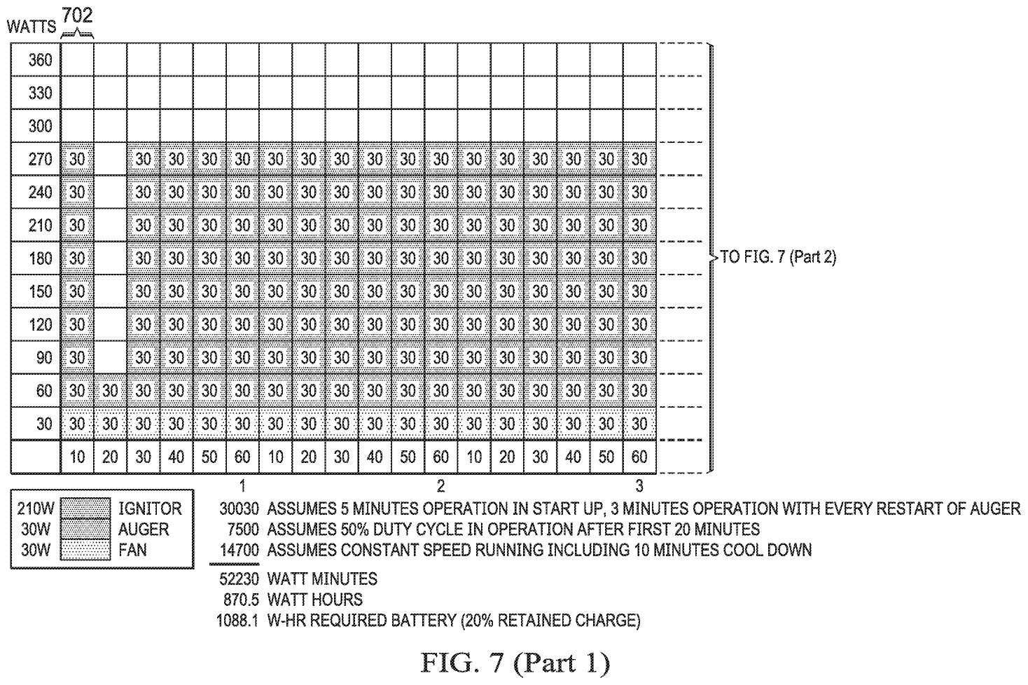

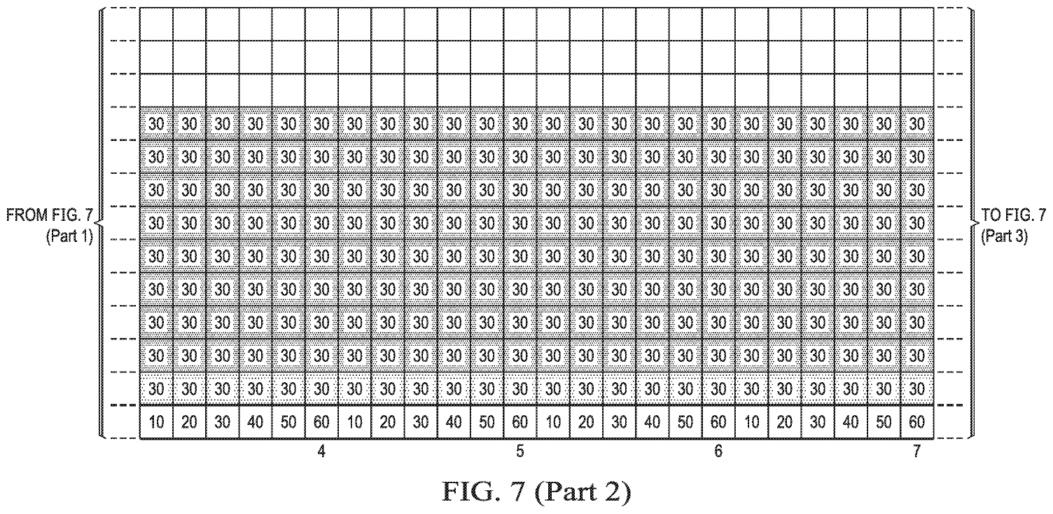

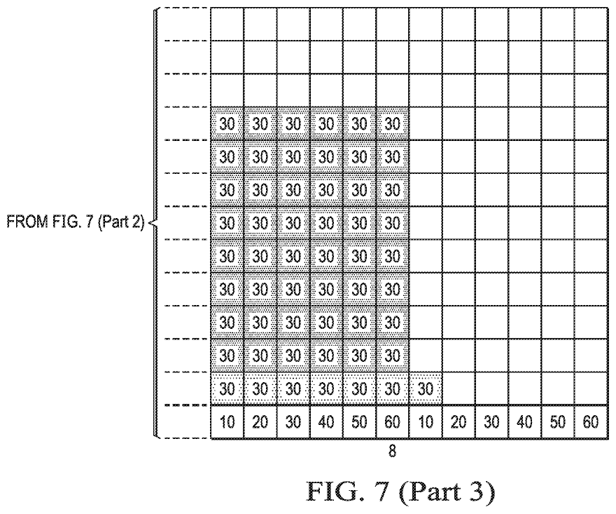

FIG. 7 illustrates operation of a grill according to the present disclosure in a smoking mode of cooking. Although the operation is shown in terms of 5-minute stages 702, in the present embodiment, the ignitor operates for only 3 minutes for every auger startup. The auger operates continuously for 20 minutes and then at a 50% duty cycle. Fan operation is continuous throughout the cooking cycle. Presuming 8 hours of operation and 10 minutes of fan-only cool down, power consumption for such a smoking cycle is 1088.1 watt-hours.

Following completion of any of the exemplary cycles discussed, the battery or batteries may be due for recharging, or exchanging for a charged battery, if cooking is to continue. It should also be understood that 5-minute stages are described for purposes of illustration, but the modes and methods of operation may be described in 1-minute stages, 10 minute stages, or stages of other lengths.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “selectively” is taken to mean the method or operation of the described component may not happen all the time or continuously. Such method or operation may occur at intervals as selected directly or indirectly by the user, by another component, or by an electronic or mechanical control mechanism.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system comprising:
a cooking chamber defining a space for food to be cooked;
a firepot inside the cooking chamber that is configured to utilize pelletized fuel to provide heat or smoke within the cooking chamber for cooking the food;
a fuel hopper defining a storage space for the pelletized fuel before delivery to the firepot;
a battery powered auger interposing the fuel hopper and the firepot and configured to selectively convey the pelletized fuel from the fuel hopper to the firepot for combustion; and
a rechargeable battery selectively providing power to the auger.

2. The system of claim 1, further comprising a direct current, variable speed auger motor that rotates the auger.

3. The system of claim 2, further comprising a user control for selectively activating the variable speed auger motor.

4. The system of claim 3, further comprising a microcontroller selectively operating the variable speed auger motor in predetermined intervals of operation based on the user control.

5. The system of claim 4, wherein the microcontroller selectively operates the variable speed auger motor at different speeds at different times based on the user control.

6. The system of claim 5, further comprising an ignitor powered by the battery and configured to ignite fuel inside the firepot.

7. The system of claim 6, wherein the ignitor is selectively activated by the microcontroller based on the user control.

8. The system of claim 7, further comprising a fan powered by the battery and providing combustion air to the firepot.

9. The system of claim 8, wherein the fan is selectively activated by the microcontroller based on the user control.

10. The system of claim 9, wherein the microcontroller provides a control program for the ignitor, fan, and auger motor based on the user control that comprises:
at least one stage where the ignitor, fan, and auger motor are all active;
at least one stage where the only the auger and fan are active; and
at least one stage where only the fan is active.

11. The system of claim 9, further comprising a battery compartment affixed to the cooking chamber and providing an electrical interface to the battery via the microcontroller.

12. The system of claim 11, further comprising a battery charger operable on alternating current power and configured to recharge the battery.

13. A system comprising:
a cooking chamber that is provided heat and smoke from a firepot therein for preparing food inside the cooking chamber;
a fuel hopper outside the cooking chamber for receiving pelletized fuel;
an auger operable to move fuel from the fuel hopper into the firepot when rotated by an auger motor;
an ignitor associated with the firepot for igniting fuel in the firepot;
a fan that provides combustion air under positive pressure into the firepot;
a battery that powers the auger motor, the ignitor, and the fan;
a control circuit that controls power to the auger motor, ignitor, and fan from the battery; and
a user control for activating the control circuit.

14. The system of claim 13, wherein the auger motor is a variable speed, direct current motor.

15. The system of claim 14, wherein the control circuit comprises a microcontroller that selectively operates the auger motor, the ignitor, and the fan according to a program selected by the user control.

16. The system of claim 15, wherein the microcontroller selectively operates the auger motor, the ignitor, and the fan according to the program selected by the user in stages, wherein the program has at least the following stages:
a stage where the ignitor, fan, and auger motor are all active;
a stage where the only the auger and fan are active; and
a stage where only the fan is active.

17. A method comprising:
receiving pelletized cooking fuel in a hopper;
moving the pelletized fuel from the hopper to a firepot; and
combusting the pelletized fuel in the firepot to generate smoke and heat within a cooking chamber;
wherein the pelletized fuel is moved by an auger rotated by a battery powered variable speed motor.

18. The method of claim 17, further comprising igniting the pelletized fuel in the firepot with a battery powered ignitor.

19. The method of claim 18, further comprising providing pressurized combustion air into the firepot with a battery powered fan.

20. The method of claim 19, further comprising operating the auger, the ignitor, and the fan in stages comprising:
at least one stage where the ignitor, fan, and auger motor are all active;
at least one stage where the only the auger and fan are active; and
at least one stage where only the fan is active.
